(19) United States
(12) Patent Application Publication
(10) Pub. No.: US 2020/0115778 A1
(43) Pub. Date: Apr. 16, 2020

(54) ALUMINUM ALLOY FIN MATERIAL AND HEAT EXCHANGER

(71) Applicants: MITSUBISHI ALUMINUM CO., LTD., Tokyo (JP); DENSO CORPORATION, Kariya-City (JP)

(72) Inventors: Michihide YOSHINO, Shizuoka (JP); Shohei IWAO, Shizuoka (JP); Tetsuya YAMAMOTO, Kariya (JP); Takahiro SHINODA, Kariya (JP); Koichi NAKASHITA, Kariya (JP)

(73) Assignees: MITSUBISHI ALUMINUM CO., LTD., Tokyo (JP); DENSO CORPORATION, Kariya-City (JP)

(21) Appl. No.: 16/653,447

(22) Filed: Oct. 15, 2019

(30) Foreign Application Priority Data
Oct. 16, 2018 (JP) 2018-194753

(51) Int. Cl. C22C 21/10; B23K 1/00; F28F 21/08

(52) U.S. Cl. CPC C22C 21/10; B23K 2103/10; F28F 21/084; B23K 1/0012

(57) ABSTRACT

An aluminum alloy fin material and a heat exchanger having excellent moldability, strength, resistance to brazing erosion and durability are provided. The aluminum alloy fin material has a composition comprising, in % by mass, Zr: 0.05 to 0.3%, Mn: 1.8 to 2.5%, Si: 0.7 to 1.3%, Fe: 0.05 to 0.5%, Cu: 0.25 to 0.7%, Zn: 2.0 to 5.0%, with the balance being Al and inevitable impurities, wherein a ratio of Mn/Si in terms of content is in a range of 1.5 to 2.9, and the aluminum alloy fin material has a tensile strength before brazing of 210 to 280 MPa, a tensile strength after brazing of 175 MPa or more, an electrical conductivity after brazing of 37% IACS or more, and a solidus temperature of 605° C. or more, and has a crystal grain structure before brazing of a non-recrystallized grain structure, and has an average crystal grain size in a rolled surface after brazing of 300 μm to 2,000 μm.

The entire disclosure of Japanese patent Application No. 2018-194753, filed on Oct. 16, 2018, is incorporated herein by reference in its entirety.

### BACKGROUND OF THE INVENTION

### Field of the Invention

The present invention relates to an aluminum alloy fin material and a heat exchanger.

### Description of the Related Art

Weight of heat exchangers tends to be reduced in order to improve fuel efficiency and save spaces. For this reason, members to be used are required to have a reduced wall thickness and high strength. In particular, for fin materials, which are a constituent members of a heat exchanger, wall thickness reduction and high strength are highly required because they are used in large amounts. More specifically, thinning up to 50 μm or less has been recently required, while conventional fin materials mainly have had a thickness of 60 μm to 100 μm.

However, when high strength can be achieved by simply increasing the amount of components added, buckling of a fin occurs due to brazing erosion during brazing because of a reduction in the melting point (solidus temperature). Furthermore, since strength of a material before brazing is increased in proportion to the increase of the strength of the material after brazing, moldability is reduced, and it becomes difficult to mold a fin to have a desired shape.

### Several Inventions have been Proposed for the Above Problems

For example, International Publication No. WO2015/141698 discloses that when a crystal grain structure before brazing is a coarse recrystallized structure and the final rolling ratio is increased, excellent moldability and erosion resistance in brazing are achieved; and furthermore proposes a fin material having excellent moldability and strength after brazing by adjusting the density of second phase particles having a circle-equivalent diameter of 0.1 μm or more to 5×10⁴ particles/mm² or more in the metallographic structure before brazing.

Furthermore, Japanese Patent Laid-Open No. 2008-308761 discloses a method for producing an aluminum alloy material having a final sheet thickness of 0.1 mm or less, in which an aluminum alloy molten metal is cast into a sheet material having a sheet thickness of 2 to 12 mm by a continuous casting rolling process, the material is immediately wounded to a coiled shape, and the aluminum alloy material wounded to a coiled shape is cooled at an average cooling rate of 15° C./hour or more, then the material is unwound, and cold rolled at least twice, and annealed at least twice. This can prevent the growth of precipitates in the structure of the aluminum alloy material and can suppress the progress of precipitation, and thus strength characteristics and erosion resistance can be improved.

### The Technical Problem to be Solved

However, the techniques of International Publication No. WO2015/141698 and Japanese Patent Laid-Open No. 2008-308761 have the problem caused by the following factors.

The problem with International Publication No. WO2015/141698 is that when, in particular, a fin material having a small wall thickness of less than 60 μm has a coarse recrystallized structure, the anisotropy of the material is increased, and thus moldability is decreased for example, the variation of ridge heights of fins are likely to occur. Furthermore, although Al—Mn-based second phase particles containing Mn of 0.1 μm or more are not easily solid-soluted at the time of braze-heating as described in International Publication No. WO2015/141698, their particle size is further increased due to the growth of grains in brazing. Then, the problem is that particles of 0.1 μm or more are less likely to contribute to dispersion strengthening and thus it is difficult to achieve high strength.

Furthermore, although the amount of Mn and Si is defined in International Publication No. WO2015/141698, Mn and Si are elements which form a compound and interact with each other, so that it is not enough for improving properties only by specifying the individual amounts to be added. More specifically, in a material to which Cu is added, an Al—Mn compound or an Al—Mn—Fe compound is precipitated on grain boundaries after braze heat treatment; furthermore, starting from those precipitates, a precipitate containing Cu precipitate coarsely on grain boundaries. Since Cu contributes to strength in the form of a solid solution, strength is reduced when this phenomenon occurs. Another problem is that Cu which has been precipitated on grain boundaries promotes intergranular corrosion and thus corrosion resistance is decreased.

Furthermore, considering that the crystal grain structure before brazing is not specified and intermediate annealing is performed at high temperature in Japanese Patent Laid-Open No. 2008-308761, the material has a coarse recrystallized structure before brazing and thus has low moldability. Furthermore, since the first annealing is performed after casting without strain load at high temperature or for a short time, dispersion of particles is likely to be non-homogeneous and precise control of dispersed particles before brazing is difficult. Moreover, a coarse distribution of dispersed particles causes a reduction in strength after brazing. Probably to compensate for that, very expensive Sc was added thereto, and thus the cost is increased.

The present invention has been made in view of the above problems, and an object of the present invention is to provide an aluminum alloy fin material having excellent moldability, strength, resistance to brazing erosion, durability and the like.

### SUMMARY OF THE INVENTION

In the present invention, components of a fin material are appropriately adjusted and, as measure to improve resistance to brazing erosion in brazing, a predetermined or higher melting point (solidus temperature) is set and crystal grain size is made coarse in brazing to ensure the resistance to brazing erosion. Furthermore, an excellent fin having high strength after brazing and excellent moldability is obtained by adjusting the strength before brazing to an appropriate range and forming the crystal grain structure before brazing to a non-recrystallized structure.

Moreover, a fin material having excellent strength and corrosion resistance is obtained by taking advantage of effects of the respective additive elements by specifying the added amount of the respective elements and specifying the ratio of the added amount of Mn and Si (Mn/Si ratio). More specifically, the material can contain a larger amount of Cu and achieves excellent strength.

Accordingly, a first aspect of the aluminum alloy fin materials of the present invention has a composition comprising, in % by mass, Zr: 0.05 to 0.3%, Mn: 1.8 to 2.5%, Si: 0.7 to 1.3%, Fe: 0.05 to 0.5%, Cu: 0.25 to 0.7%, Zn: 2.0 to 5.0%, with the balance being Al and inevitable impurities, wherein a ratio of Mn/Si in terms of content is in a range of 1.5 to 2.9, and the aluminum alloy fin material has a tensile strength before brazing of 210 to 280 MPa, a tensile strength after brazing of 175 MPa or more, an electrical conductivity after brazing of 37% IACS or more, and a solidus temperature of 605° C. or more, has a crystal grain structure before brazing of a non-recrystallized grain structure, and has an average crystal grain size in a rolled surface after brazing of 300 μm to 2,000 μm.

An aluminum alloy fin material according to a second aspect of the present invention is an aluminum alloy fin material according to the above aspect of the present invention, wherein, Mn-containing Al—Mn-based particles having a circle-equivalent diameter of 400 nm or less among second phase particles distributed in matrix before brazing, have an average diameter in a range of 40 to 90 nm, and a number density thereof is within a range of 6 to 13 particles/μm².

An aluminum alloy fin material according to a third aspect of the present invention is an aluminum alloy fin material according to the above aspect of the present invention, wherein, Mn-containing Al—Mn-based particles having a circle-equivalent diameter of 400 nm or less among second phase particles distributed in matrix after brazing, have an average diameter in a range of 50 to 100 nm, and a number density thereof is 5 particles/μm² or more.

The heat exchanger of the present invention is obtained by brazing the aluminum alloy fin material according to any of the above aspects and an aluminum material.

Hereinafter the reason for limiting the composition and other matters in the present invention will be described. The following components are in % by weight.

### (1) Composition

Zr: 0.05 to 0.3%

Zr generates a fine intermetallic compound of Al₃Zr or Al₃(Zr, Si) with Al, and thus has the effect of improving the strength of a fin after brazing. This compound, in particular, is less likely to be solid-soluted in the matrix during brazing treatment in contrast to Mn-containing Al—Mn-based particles, and therefore has the effect of improving strength after brazing effectively. When the content of Zr is less than 0.05%, effects thereof are not sufficiently exhibited. When the content of Zr is more than 0.3%, a large intermetallic compound is generated in casting, so that the productivity of an aluminum alloy fin is significantly reduced. Thus, the content of Zr is set to the above range.

The lower limit of the content of Zr is preferably set to 0.08% and the upper limit of the content of Zr is preferably set to 0.25% for the same reason.

Mn: 1.8 to 2.5%

Mn generates an Al—Mn—Si-based or Al—(Mn, Fe)—Si-based intermetallic compound (dispersed particles) with Si or Fe and the like, and thus has the effect of improving the strength of a fin after brazing. When the content of Mn is less than 1.8%, effects thereof are not sufficiently exhibited. When the content of Mn is more than 2.5%, a large intermetallic compound is generated in casting, so that the productivity of an aluminum alloy fin is significantly decreased. Thus, the content of Mn is set to the above range.

The lower limit of the content of Mn is preferably set to 1.9% and the upper limit of the content of Mn is preferably set to 2.4% for the same reason.

Si: 0.7 to 1.3%

Si is included in order to precipitate an Al—Mn—Si-based or Al—(Mn, Fe)—Si-based intermetallic compound (dispersed particles) to obtain strength after brazing based on dispersion strengthening. However, when the content of Si is less than 0.7%, the effect of dispersion strengthening caused by the Al—Mn—Si-based or Al—(Mn, Fe)—Si-based intermetallic compound is small, and the desired strength after brazing cannot be obtained. When the content of Si is more than 1.3%, the solidus temperature (melting point) is decreased and significant brazing erosion is likely to occur in brazing. Thus, the content of Si is set to the above range.

The lower limit of the content of Si is preferably set to 0.85% and the upper limit of the content of Si is preferably set to 1.2% for the same reason.

Fe: 0.05 to 0.5%

When Fe is included, dispersion strengthening is achieved by an Al—(Mn, Fe)—Si-based compound, and strength after brazing is improved. When the content of Fe is less than 0.05%, a sufficient effect of improving strength cannot be obtained. Furthermore, since high purity base metal must be used, the cost for manufacturing materials is increased.

Meanwhile, when the content of Fe is more than 0.5%, a large intermetallic compound is generated in casting, so that the productivity of an aluminum alloy fin is significantly decreased. Thus, the content of Fe is set to the above range.

The lower limit of the content of Fe is preferably set to 0.15% and the upper limit of the content of Fe is preferably set to 0.35% for the same reason.

Cu: 0.25 to 0.70%

Cu is included in order to improve strength after brazing by solid solution strengthening. When the content of Cu is less than 0.25%, sufficient effects cannot be obtained. When the content of Cu is more than 0.70%, potential is made noble, so that the effect of a sacrificial anode against a fin material for a tube material is decreased. Furthermore, self-corrosion resistance is deteriorated. Thus, the content of Cu is set to the above range.

The lower limit of the content of Cu is preferably set to 0.40% and the upper limit of the content of Cu is preferably set to 0.60% for the same reason.

Zn: 2.0 to 5.0%

Zn is included in order to make potential noble, thereby obtaining the effect of a sacrificial anode. When the content of Zn is less than 2.0%, sufficient effects of a sacrificial anode cannot be obtained. When the content of Zn is more than 5.0%, the potential is made extremely noble, so that the self-corrosion resistance of the fin material itself is likely to be decreased. Thus, the content of Zn is set to the above range.

The lower limit of the content of Zn is preferably set to 2.2% and the upper limit of the content of Zn is preferably set to 4.5% for the same reason.

Other Inevitable Impurities

Other elements, for example, can be contained in the alloy fin material of the present invention include Mg, Cr, and Ni, each of which in an amount of 0.05% or less. It is desirable that the allowable upper limit of their total amount is set to 0.15% or less.

Ratio of Mn/Si (Content): 1.5 to 2.9

In a material to which 0.25% or more of Cu is added, when the cooling rate after braze heat treatment is low, an Al—Mn compound or an Al—Mn—Fe compound is precipitated on grain boundaries after braze heat treatment, furthermore, starting from those precipitates, a precipitate containing Cu precipitates coarsely on grain boundaries. Moreover, when 0.32% or more of Cu is added, coarse precipitates are likely to be formed even at a high cooling rate. The same phenomenon may occur in particles when a heat exchanger is exposed to a high temperature of 150° C. or more during use. Since Cu contributes to strength in the state of a solid solution, the amount of Cu in the state of a solid solution is reduced when the phenomenon occurs, and thus the strength is decreased. Furthermore, Cu which has been precipitated on grain boundaries promotes intergranular corrosion and thus corrosion resistance is decreased. By contrast, Al—Mn—Si compounds or Al—Mn—Si—Fe compounds are unlikely to become a starting point of precipitation of precipitates containing Cu, and thus the above problem can be avoided. A Mn-based precipitate will become which form, it depends on the Mn/Si ratio of their contents and/or conditions of heat treatment in the process of manufacturing materials. When the Mn/Si ratio is more than 2.9, the precipitate becomes the form of an Al—Mn compound or an Al—Mn—Fe compound. Thus, the Mn/Si ratio is set to 2.9 or less in the present invention. In contrast, when the Mn/Si ratio is less than 1.5, the melting point of a fin material is decreased due to an excessive amount of Si, and thus the lower limit of Mn/Si is set to 1.5.

It is desirable that the ratio of Mn/Si (content) is 1.7 or more, and it is desirable that the ratio of Mn/Si (content) is 2.6 or less for the same reason.

### (2) Tensile Strength

Tensile Strength Before Brazing: 210 to 280 MPa

In corrugation molding of a fin material, if the strength before brazing is excessively high, the shape of the fin to be formed is unstable. For example, fin pitches become uneven. By contrast, if the strength is low, the material is not stiff, and thus molding defects occur. Thus, the tensile strength before brazing is set to the above range. It is desirable that the tensile strength before brazing is set to 220 MPa or more and it is desirable that the tensile strength before brazing is set to 270 MPa or less for the same reason.

Tensile Strength after Brazing: 175 MPa or More

The tensile strength after brazing needs to be 175 MPa or more in order to ensure the strength when the material is used as a heat exchanger. The tensile strength after brazing is therefore set to the above range.

It is desirable that the tensile strength after brazing is set to 185 MPa or more for the same reason.

### (3) Electrical Conductivity

Electrical Conductivity after Brazing: 37% IACS or More

Electrical conductivity is an alternative property for heat conductivity. The electrical conductivity after brazing needs to be 37% IACS or more in order to ensure properties when the material is used as a heat exchanger. It is more desirable that the electrical conductivity after brazing is set to 38% IACS or more for the same reason.

### (4) Solidus Temperature

Solidus Temperature: 605° C. or More

In brazing, usually, a material to be brazed is heated to about 600° C., thus when an alloy material having a low solidus temperature is used, fins are melted so that maintaining the shape is difficult. For this reason, it is necessary that a solidus temperature of the fin material is set to 605° C. or more. It is more desirable that a solidus temperature of the fin material is 610° C. or more.

### (5) Crystal Structure

Crystal Grain Structure Before Brazing: Non-Recrystallized Grain Structure

In the case of a thin-walled fin material, when the crystal grain structure before brazing is a coarse recrystallized structure, the anisotropy of the material is increased, and moldability is reduced for example the variation of ridge heights of fins are likely to occur. Thus, the crystal grain structure before brazing is designed to be a non-recrystallized grain structure.

A recrystallized structure is a structure in which dislocations introduced by final rolling are tangled in recrystallized grains which have been formed by annealing before the final rolling. Meanwhile, a non-recrystallized structure refer to a structure with dislocation cells formed by annealing before the final rolling or with dislocations introduced in the final rolling in the subgrain.

Furthermore, it is also desired to control precisely the distribution state (average particle size and number density) of dispersed particles in addition to the number density in order to improve properties of a fin material.

Average Crystal Grain Size in Rolled Surface after Brazing: 300 μm to 2,000 μm

When the material has an average crystal grain size of less than 300 μm in the rolled surface after brazing, the material is susceptible to brazing erosion when brazing of a heat exchanger is performed. When the material has an average crystal grain size of more than 2,000 μm in the rolled surface after brazing, coarsening of crystal grains is excessive, thus the strength after brazing is reduced. Thus, the average crystal grain size in the rolled surface after brazing is set to the above range. It is desirable that the above grain size is 350 μm or more and it is desirable that the above grain size is 1,800 μm or less for the same reason.

(6) State of Distribution of Second Phase Particles

Average diameter of Mn-containing Al—Mn-based particles having a circle-equivalent diameter of 400 nm or less, among second phase particles distributed in matrix before brazing is 40 to 90 nm, and number density thereof is 6 to 13 particles/μm′.

When second phase particles before brazing have an average particle diameter of less than 40 nm, strength before brazing is excessively increased. Conversely, when they have an average particle diameter of more than 90 nm, the effect of improving strength cannot be obtained, resulting in an insufficient strength before brazing. Furthermore, when the number density of second phase particles is less than 6 particles/μm², strength after brazing is decreased. Conversely, when the number density is more than 13 particles/μm², the strength of the material is excessively increased. Thus, it is desirable that the average diameter and the number density of the second phase particles are set to the above range.

For the state of distribution, particles having a circle-equivalent diameter of 15 nm or more are counted.

Average diameter of Mn-containing Al—Mn-based particles having a circle-equivalent diameter of 400 nm or less, of second phase particles distributed in matrix after brazing is 50 to 100 nm, number density thereof is 5 particles/μm² or more.

When second phase particles after brazing have an average particle diameter of less than 50 nm, or an average particle diameter of more than 100 nm, and the number density thereof is less than 5 particles/μm², the strength after brazing is decreased. Thus, it is desirable that the average diameter and the number density of the second phase particles are set to the above range. It is more desirable that the second phase particles after brazing have an average diameter of 60 nm to 90 nm and the number density thereof is 6 particles/μm² or more for the same reason.

### Advantageous Effect of Invention

According to the present invention, an aluminum alloy fin material and a heat exchanger having excellent resistance to brazing erosion, moldability, strength and corrosion resistance can be obtained.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 shows a perspective view illustrating a heat exchanger for an automobile made of aluminum according to an embodiment of the present invention; and

FIG. 2 shows a view illustrating a model for evaluating brazing in Examples of the present invention.

### DETAILED DESCRIPTION OF THE EMBODIMENTS

Hereinafter, an embodiment of the present invention will be described with reference to the drawings. However, the scope of the invention is not limited to the disclosed embodiments.

Provided is an aluminum alloy having a composition comprising, in % by mass, Zr: 0.05 to 0.3%, Mn: 1.8 to 2.5%, Si: 0.7 to 1.3%, Fe: 0.05 to 0.5%, Cu: 0.25 to 0.7%, Zn: 2.0 to 5.0%, with the balance being Al and inevitable impurities, wherein a ratio of Mn/Si in terms of content is in the range of 1.5 to 2.9.

An aluminum alloy fin material can be produced by casting the above alloy by continuous casting rolling (CC process) using, for example, a twin roll caster, subjecting the cast sheet to homogenizing treatment and cold rolling. It is desirable that the cooling rate in casting is adjusted to the range of 50 to 400° C./second.

When the cooling rate in casting is less than 50° C./second, the supersaturated solid solution amount of elements such as Mn, Si and Fe towards the matrix is reduced, making it difficult to control the dispersion state of second phase particles of 400 nm or less to the desired state in the subsequent heating treatment. In contrast, when the cooling rate in casting is more than 400° C./second, the amount of supersaturated solid solution is excessively increased, also making it difficult to control the dispersion state.

The cast sheet obtained is preferably subjected to cold rolling at 5 to 30% and then subjected to the first heat treatment. Introduction of strain in the material by cold rolling facilitates precipitation when the heat treatment, making it easy to control the dispersion state. Then the first heat treatment is carried out. In the first heat treatment, the maintaining temperature is set to the range of 350 to 550° C. and the maintaining time is set to 3 to 40 hours, and the second phase particles are precipitated finely and homogeneously at high density.

When the maintaining temperature is less than 350° C., the size of dispersed particles to be precipitated is excessively fine. In contrast, when the maintaining temperature is more than 550° C., the size of dispersed particles to be precipitated becomes excessively coarse.

Furthermore, when the maintaining time is less than 3 hours, the amount of precipitation is insufficient. When the maintaining time is more than 40 hours, dispersed particles grow and cause a non-homogeneous distribution.

Subsequently, cold rolling is performed at 70% or more, and then the second heat treatment is performed. Since second phase particles have been homogeneously and finely distributed in the first heat treatment, and the size of the second phase particles is increased while maintaining the homogeneity of the second phase particles which have been precipitated in the first heat treatment, due to strain introduced by cold rolling, this provides the desired dispersion state useful for improving properties. If the second heat treatment is omitted, a homogeneous and fine distribution of second phase particles is unlikely to be obtained, and the cold rolling ratio until temper annealing is increased, therefore the tensile strength before brazing is increased, causing a reduction in moldability.

It is desirable that the maintaining temperature is 370 to 530° C. and the maintaining time is 1 to 20 hours in the second heat treatment.

When the maintaining temperature is less than 370° C., dispersed particles cannot grow, and thus their size is excessively fine. When the maintaining temperature is more than 530° C., the size of dispersed particles to be precipitated becomes excessively coarse, and besides, only particular particles are likely to grow, causing a non-homogeneous distribution.

When the maintaining time is less than 1 hour, dispersed particles do not grow completely and thus the desired state cannot be obtained. When the maintaining time exceeds 20 hours, dispersed particles grow too much, causing a non-homogeneous distribution.

After the second heat treatment, the sheet goes through the process of cold rolling, temper annealing and the final cold rolling to be produced as an H1n material (JIS Standard, tempered). For the temperature of temper annealing, temper annealing is preferably carried out at a temperature equal to or lower than the second heat treatment temperature so as to not destroy the dispersion state which has been adjusted until the second heat treatment. This condition is not particularly limited, and normally the maintaining temperature is in the range of 200 to 500° C. and the maintaining time is in the range of 2 to 8 hours.

Strength before brazing can be further reduced by adding heat treatment of low temperature after the final rolling. However, when the temperature is excessively high, elongation is increased as the strength is reduced, and burr is likely to be formed in the molding of a fin. Furthermore, when the temperature is excessively low, the desired effect cannot be obtained. Thus, the suitable temperature range is 100 to 250° C. and the suitable time is 1 to 10 hours.

It is desirable that cold rolling is performed at a rolling ratio of 40 to 80% after the second heat treatment. When the rolling ratio is excessively low, the amount of strain stored in the material reduces, and a fin of H1n temper is not completely recrystallized in brazing, thus is significantly eroded. Conversely, when the rolling ratio is excessively high, the strength before brazing excessively increases.

It is desirable that the maintaining temperature is 180 to 250° C. and the maintaining time is 2 to 10 hours in temper annealing. When the maintaining temperature is high, a non-crystallized structure cannot be obtained. When the maintaining temperature is low, strength before brazing is excessively increased.

It is desirable that the rolling ratio in the final cold rolling is set to 5 to 20%. When the rolling ratio in the final cold rolling is less than 5%, rolling is difficult, and when the final cold rolling is more than 20%, strength before brazing is excessively increased.

The sheet thickness is preferably formed to 0.04 to 0.06 mm by performing the final cold rolling. However, the final sheet thickness is not particularly limited in the present invention.

A fin material for a heat exchanger can be obtained by the above process.

The resulting fin material has excellent strength, conductivity, corrosion resistance and brazing properties.

In particular, the fin material has a non-recrystallized grain structure and a solidus temperature of 605° C. or more before brazing.

The fin material has a tensile strength before brazing of 210 to 280 MPa and has excellent strength, conductivity and corrosion resistance.

Furthermore, it is desirable that, before brazing, particles having a circle-equivalent diameter of 400 nm or less among the second phase particles distributed in matrix have an average diameter in the range of 40 to 90 nm, and the number density thereof is in the range of 6 to 13 particles/μm².

The resulting fin material is, for example, corrugated to form a fin, and the fin is combined with an aluminum member for a heat exchanger, such as a header, a tube and a side plate, and joined by brazing, thus a heat exchanger can be produced. The composition of the aluminum alloy material to be brazed with the fin material is not particularly limited, and an aluminum material having a suitable composition can be used. The aluminum material includes pure aluminum in addition to aluminum alloy materials.

Conditions and methods of heat treatment in brazing (e.g., brazing temperature, atmosphere, presence of flux, types of brazing materials) are not particularly limited in the present invention. Brazing can be performed by the desired method.

The fin material has a tensile strength of 175 MPa or more, an electrical conductivity of 37% IACS or more, and an average crystal grain size in the rolled surface of 300 μm to 2,000 μm, after brazing. Heat treatment conditions of brazing are assumed according to those properties, which are to increase temperature from room temperature to 600° C. within about 6 minutes and then without maintaining the temperature, cool the material to room temperature at 100° C./minute. Brazing conditions are not particularly limited and can be appropriately determined in the present invention.

It is desirable that, particles having a circle-equivalent diameter of 400 nm or less among the second phase particles distributed in matrix after brazing have an average diameter in the range of 50 to 100 nm, and the number density is 5 particles/μm² or more.

The heat exchanger obtained is equipped with the fin material according to the present embodiment, and thus has excellent brazing joining properties, and excellent strength, conductivity and corrosion resistance.

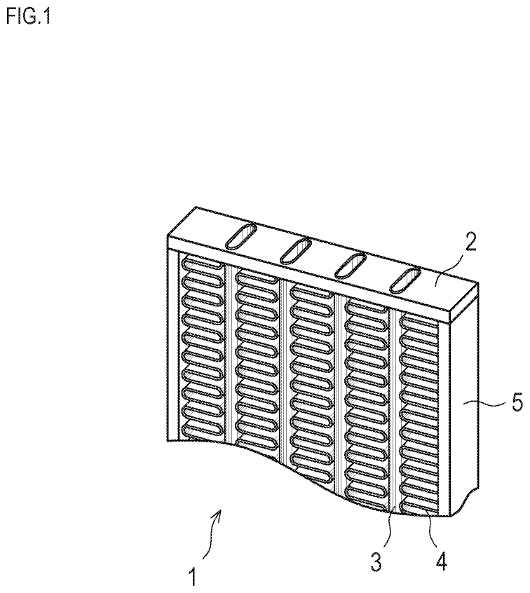

FIG. 1 shows heat exchanger 1 produced by assembling tube 3, header 2 and side plate 5 in the fin 4 of the present embodiment and then brazing.

The present embodiment can provide an aluminum alloy fin material for a heat exchanger and a heat exchanger having excellent strength, conductivity, corrosion resistance and brazing properties.

In the present embodiment, Mn was added by an amount larger than that in conventional materials, other components were appropriately adjusted, and the dispersion state before and after brazing of second phase particles having a predetermined or smaller size was controlled at high accuracy. More specifically, for the size of second phase particles, the impact of the size of second phase particles on the strength before and after brazing was investigated. It has been found that the larger the size of second phase particles, the strength before brazing is decreased; by contrast, regarding the strength after brazing, the smaller the size of second phase particle, the strength after brazing is increased, but the strength after brazing is substantially saturated when the size reaches a predetermined size or less. Thus, both a reduction of strength before brazing and an improvement of strength after brazing, which are contrary to each other, are achieved by suitably dispersing second phase particles having a pre-determined size.

### Example 1

An aluminum alloy having the composition shown in Table 1 (the balance being Al and inevitable impurities) was produced by a twin roll casting method. The cooling rate was 200° C./second.

The aluminum alloy cast sheet obtained was sequentially subjected to cold rolling, the first heat treatment, cold rolling, the second heat treatment, and the final cold rolling. The conditions of the first heat treatment and the conditions of the second heat treatment are shown in the table.

After the second heat treatment, cold rolling, temper annealing and the final cold rolling were performed to obtain an aluminum alloy fin material having a desired plate thickness. The final rolling ratio in the final cold rolling is shown in the table.

Cold rolling after the first heat treatment was performed at 98%, cold rolling after the second heat treatment was performed at 50%, and temper annealing was performed at 250° C. X 5 hours, and then the resultant was rolled at the final rolling ratio. Some materials were subjected to a heat treatment of low temperature after the final rolling.

Subsequently, with respect to the obtained aluminum alloy fin material, the tensile strength, the crystal grain structure, the melting point and the dispersion state of the second phase particles of the resulting aluminum alloy fin material were measured by the method described below.

The aluminum alloy fin material was also braze-heated in the condition described below, and the tensile strength, the electrical conductivity, the crystal grain size in the rolled surface and the dispersion state of second phase particles were measured after braze-heating.

Furthermore, resistance to brazing erosion, corrugation moldability and corrosion resistance were evaluated by the method described below. Then, the results of measurement and the results of evaluation were comprehensively assessed.

The results of measurement and the results of evaluation are shown in the table.

### <Tensile Strength Before Brazing>

Before brazing, a sample was cut parallel to the rolling direction to prepare a JIS No. 13 B shaped test piece. A tensile test was performed to measure tensile strength. The speed of tensile was set to 3 mm/minute.

### <Crystal Grain Structure Before Brazing>

Before brazing, a cross section parallel to the rolling direction is processed by a cross section polisher and then OIM measurement is performed by SEM-EBSD at a magnification of 5,000 times to determine the presence of subgrains based on the boundary map. The area of the visual field is 10×20 μm and the step size is 0.05 μm, and 10 visual fields are measured. Structures in which a subgrain structure accounts for more than 50% of the visual field measured are determined as a non-recrystallized structure. A region surrounded by grain boundaries with a misorientation of 2° or more in the EBSD measurement is defined as a subgrain.

### <Melting Point (Solidus Temperature)>

The solidus temperature of the fin material prepared was measured by DTA with a usual method. The rate of temperature increase at the time of measurement was set by 20° C./minute from room temperature to 500° C., and by 2° C./minute in the range of 500 to 600° C. Alumina was used as a reference. The results are shown in the column of melting point.

### <Dispersion State (Average Particle Diameter, Number Density) of Second Phase Particles>

Before brazing, a cross section parallel to the rolling direction was processed by a cross section polisher and then 10 visual fields were observed with FE-SEM at a magnification of 30,000 times. Subsequently, the dispersion state was quantified by using an image analysis software to calculate the average particle diameter (μm) and the number density (particles/μm²) of particles having an particle diameter of 400 nm or less.

### <Heat Treatment Equivalent to Brazing>

In the heat treatment equivalent to brazing, the temperature was increased from room temperature to 600° C. in 6 minutes and then the material was cooled to room temperature at 100° C./minute without maintaining the temperature.

<Tensile Strength after Brazing>

After brazing, a sample was cut parallel to the rolling direction to prepare a JIS No. 13 B shaped test piece. A tensile test was performed to measure tensile strength. The speed of tensile was 3 mm/minute.

### <Dispersion State (Average Particle Diameter, Number Density) of Second Phase Particles>

After brazing, a cross section parallel to the rolling direction was processed by a cross section polisher and then 10 visual fields were observed with FE-SEM at a magnification of 30,000 times. Subsequently, the dispersion state was quantified by using an image analysis software to calculate the average particle diameter (μm) and the number density (particles/μm²) of particles having an particle diameter of 400 nm or less.

<Crystal Grain Size in Rolled Surface after Brazing>

After brazing, the crystal grain size in the rolled surface was measured with a stereomicroscope.

For the method of measurement, the fin material prepared was subjected to heat treatment equivalent to brazing, then immersed in a DAS solution for a predetermined time, and was etched until the crystal grain structure in the rolled surface can be clearly seen. Then the crystal grain structure in the rolled surface was observed with a stereomicroscope. The standard magnification of observation was 20 times and the magnification of observation was accordingly changed depending on the size of crystal grains when crystal grains were significantly coarse or fine. The crystal grain structure of 5 visual fields was photographed, and the material was cut parallel to the rolling direction and the size of the crystal grain was measured by a cutting method.

### <Electrical Conductivity>

After brazing, electrical conductivity was measured by the measuring method for conductivity described in JIS H-0505 at room temperature with a double bridge type conductivity meter.

### <Resistance to Brazing Erosion>

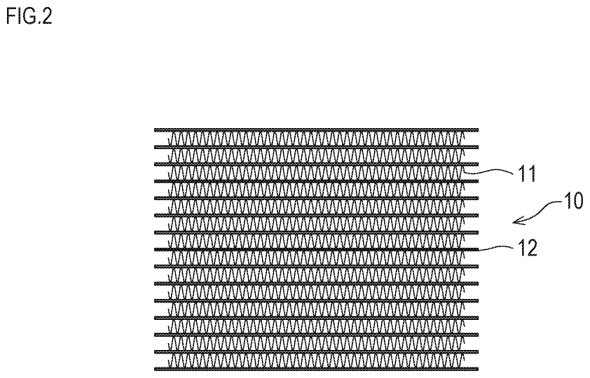

As shown in FIG. 2, fin 11 was assembled to form a joint shape of fin 11/tube 12 with a JIS A4045/A3003 one-side brazing material having a sheet thickness of 0.20 mm (cladding ratio of brazing material being 10%), and, then was subjected to brazing. A cross section of mini-core 10 prepared by brazing was observed to determine the presence of buckling and erosion.

Those in which erosion penetrating though the sheet thickness and buckling occurred in 15% or less of the portions joined, were rated as ◯, and those in which erosion penetrating though the sheet thickness and buckling occurred in more than 15% of the portions were rated as X.

### <Moldability>

A corrugation molding machine was adjusted so that fins had a width of 20 mm, a fin height of 5 mm and a fin pitch (between ridges) of 3 mm. Then, 50 ridges were formed for each of fin ridges and the height of the respective ridges was measured to evaluate variation in the ridge height. Those having 10 or more ridges with a ridge height of 5 mm±12% or more were rated as X, those having ridges in the range of 5 to 9 were rated as Δ and those having ridges less than 5 were rated as ◯.

### <Corrosion Resistance>

As shown in FIG. 2, corrugated fin 11 was assembled to form a joint shape of fin 11/tube 12 with a JIS A4045/A3003 one-side brazing material having a sheet thickness of 0.20 mm (cladding ratio of brazing material being 10%), and then was subjected to brazing to produce mini-core 10. This mini-core was exposed to SWAAT for 20 days. Those in which corrosion having a depth of 0.10 mm or more occurred in the tube were rated as X, and those in which corrosion having a depth of less than 0.10 mm occurred in the tube were rated as ◯.

### <Comprehensive Evaluation>

Those having an electrical conductivity of 37% IACS or more, a melting point of 605° C. or more, whose moldability alone was rated as Δ, and having a strength after brazing of 175 MPa or more were determined as ◯.

Those having an electrical conductivity of 37% IACS or more, a melting point of 605° C. or more, whose all properties were rated as ◯, and having a strength after brazing of 175 MPa or more were determined as ◯◯.

Those having an electrical conductivity of 37% IACS or more, a melting point of 605° C. or more, whose all properties were rated as ◯, and having a strength after brazing of 185 MPa or more were determined as ◯◯◯.

Furthermore, those any of whose properties is rated as X or having a strength after brazing of less than 175 MPa were determined as X.

TABLE 1

| | | | | | | | | | | | Final | |
|---|---|---|---|---|---|---|---|---|---|---|---|---|
| | | | | | | | | | 1st | 2nd | rolling | Heat |
| | | Test material component (% by mass) | | | | | | | heat | heat | ratio | treatment |
| Test material No. | | Mn | Si | Fe | Cu | Zn | Zr | Mn/Si | treatment | treatment | (%) | at low |
| Comperative | 1 | 2.1 | 0.8 | 0.20 | 0.45 | 2.9 | 0.03 | 2.63 | 430° C. × 12 h | 430° C. × 6 h | 15 | None |
| example | | | | | | | | | | | | |
| Present example | 2 | 2.1 | 0.8 | 0.20 | 0.45 | 2.9 | 0.15 | 2.63 | 430° C. × 12 h | 430° C. × 6 h | 15 | None |
| Present example | 3 | 2.1 | 0.8 | 0.20 | 0.45 | 2.9 | 0.25 | 2.63 | 430° C. × 12 h | 430° C. × 6 h | 15 | None |
| Comperative | 4 | 2.1 | 0.8 | 0.20 | 0.45 | 2.9 | 0.35 | 2.63 | 430° C. × 12 h | 430° C. × 6 h | 15 | None |
| example | | | | | | | | | | | | |
| Comperative | 5 | 1.6 | 0.8 | 0.15 | 0.45 | 3.1 | 0.19 | 2.00 | 430° C. × 12 h | 430° C. × 6 h | 15 | None |
| example | | | | | | | | | | | | |
| Present example | 6 | 1.8 | 0.8 | 0.15 | 0.45 | 3.1 | 0.19 | 2.25 | 430° C. × 12 h | 430° C. × 6 h | 15 | None |
| Present example | 7 | 2.3 | 0.8 | 0.15 | 0.45 | 3.1 | 0.19 | 2.88 | 430° C. × 12 h | 430° C. × 6 h | 15 | None |
| Comperative | 8 | 2.7 | 0.8 | 0.15 | 0.45 | 3.1 | 0.19 | 3.38 | 430° C. × 12 h | 430° C. × 6 h | 15 | None |
| example | | | | | | | | | | | | |
| Comperative | 9 | 2.0 | 0.5 | 0.15 | 0.45 | 3.1 | 0.19 | 4.00 | 430° C. × 12 h | 430° C. × 6 h | 15 | None |
| example | | | | | | | | | | | | |
| Present example | 10 | 2.0 | 0.7 | 0.15 | 0.45 | 3.1 | 0.19 | 2.86 | 430° C. × 12 h | 430° C. × 6 h | 15 | None |
| Present example | 11 | 2.0 | 1.3 | 0.15 | 0.45 | 3.1 | 0.19 | 1.54 | 430° C. × 12 h | 430° C. × 6 h | 15 | None |
| Comperative | 12 | 2.0 | 1.5 | 0.15 | 0.45 | 3.1 | 0.19 | 1.33 | 430° C. × 12 h | 430° C. × 6 h | 15 | None |
| example | | | | | | | | | | | | |
| Comperative | 13 | 2.0 | 0.8 | 0.01 | 0.45 | 3.1 | 0.19 | 2.50 | 430° C. × 12 h | 430° C. × 6 h | 15 | None |
| example | | | | | | | | | | | | |
| Present example | 14 | 2.0 | 0.8 | 0.05 | 0.45 | 3.1 | 0.19 | 2.50 | 430° C. × 12 h | 430° C. × 6 h | 15 | None |
| Present example | 15 | 2.0 | 0.8 | 0.35 | 0.45 | 3.1 | 0.19 | 2.50 | 430° C. × 12 h | 430° C. × 6 h | 15 | None |
| Comperative | 16 | 2.0 | 0.8 | 0.60 | 0.45 | 3.1 | 0.19 | 2.50 | 430° C. × 12 h | 430° C. × 6 h | 15 | None |
| example | | | | | | | | | | | | |
| Comperative | 17 | 2.0 | 0.8 | 0.15 | 0.20 | 3.1 | 0.19 | 2.50 | 430° C. × 12 h | 430° C. × 6 h | 15 | None |
| example | | | | | | | | | | | | |
| Present example | 18 | 2.1 | 0.8 | 0.20 | 0.44 | 3.1 | 0.19 | 2.63 | 430° C. × 12 h | 430° C. × 6 h | 15 | None |
| Present example | 19 | 2.1 | 0.8 | 0.20 | 0.66 | 3.3 | 0.19 | 2.63 | 430° C. × 12 h | 430° C. × 6 h | 15 | None |
| Comperative | 20 | 2.1 | 0.8 | 0.20 | 0.80 | 3.3 | 0.19 | 2.63 | 430° C. × 12 h | 430° C. × 6 h | 15 | None |
| example | | | | | | | | | | | | |
| Comperative | 21 | 2.1 | 0.8 | 0.20 | 0.45 | 1.5 | 0.19 | 2.63 | 430° C. × 12 h | 430° C. × 6 h | 15 | None |
| example | | | | | | | | | | | | |
| Present example | 22 | 2.1 | 0.8 | 0.20 | 0.45 | 2.9 | 0.19 | 2.63 | 430° C. × 12 h | 430° C. × 6 h | 15 | None |
| Present example | 23 | 2.1 | 0.8 | 0.20 | 0.45 | 4.4 | 0.19 | 2.63 | 430° C. × 12 h | 430° C. × 6 h | 15 | None |
| Comperative | 24 | 2.1 | 0.8 | 0.20 | 0.45 | 5.5 | 0.19 | 2.63 | 430° C. × 12 h | 430° C. × 6 h | 15 | None |
| example | | | | | | | | | | | | |
| Comperative | 25 | 1.1 | 0.5 | 0.20 | 0.45 | 3.1 | 0.19 | 2.20 | 430° C. × 12 h | 430° C. × 6 h | 7 | None |
| example | | | | | | | | | | | | |
| Present example | 26 | 1.9 | 0.8 | 0.20 | 0.45 | 3.1 | 0.19 | 2.38 | 430° C. × 12 h | 430° C. × 6 h | 7 | None |
| Present example | 27 | 2.3 | 1.3 | 0.20 | 0.55 | 3.1 | 0.19 | 1.77 | 430° C. × 12 h | 430° C. × 6 h | 20 | None |
| Comperative | 28 | 2.3 | 1.3 | 0.20 | 0.55 | 3.1 | 0.19 | 1.77 | 430° C. × 12 h | 430° C. × 6 h | 30 | None |
| example | | | | | | | | | | | | |
| Present example | 29 | 2.1 | 1.3 | 0.20 | 0.45 | 3.1 | 0.19 | 1.62 | 430° C. × 12 h | None | 15 | None |
| Present example | 30 | 2.1 | 1.3 | 0.20 | 0.45 | 3.1 | 0.20 | 1.62 | 450° C. × 9 h | 410° C. × 4 h | 15 | None |
| Present example | 31 | 2.1 | 1.3 | 0.20 | 0.45 | 3.1 | 0.21 | 1.62 | 430° C. × 12 h | 500° C. × 9 h | 15 | None |
| Present example | 32 | 2.1 | 1.3 | 0.20 | 0.45 | 3.1 | 0.20 | 1.62 | 430° C. × 12 h | 550° C. × 5 h | 15 | None |
| Present example | 33 | 2.1 | 1.3 | 0.20 | 0.45 | 3.1 | 0.20 | 1.62 | 430° C. × 12 h | 430° C. × 6 h | 15 | None |
| Comperative | 34 | 2.3 | 1.3 | 0.20 | 0.55 | 3.1 | 0.19 | 1.77 | 430° C. × 12 h | 430° C. × 9 h | 47 | None |
| example | | | | | | | | | | | | |
| Present example | 35 | 2.3 | 1.3 | 0.20 | 0.55 | 3.1 | 0.19 | 1.77 | 430° C. × 12 h | 430° C. × 6 h | 20 | — |
| Present example | 36 | 2.1 | 1.3 | 0.20 | 0.45 | 3.1 | 0.19 | 1.62 | 430° C. × 12 h | 430° C. × 6 h | 15 | — |
| Comperative | 37 | 2.1 | 1.3 | 0.20 | 0.45 | 3.1 | 0.19 | 1.62 | 430° C. × 12 h | None | 15 | None |
| example | | | | | | | | | | | | |
| Present example | 38 | 2.1 | 1.3 | 0.20 | 0.45 | 3.1 | 0.20 | 1.62 | 475° C. × 5 h | None | 15 | None |
| Present example | 39 | 2.1 | 1.3 | 0.20 | 0.45 | 3.1 | 0.21 | 1.62 | 530° C. × 10 h | None | 15 | None |
| Present example | 40 | 2.1 | 1.3 | 0.20 | 0.45 | 3.1 | 0.20 | 1.62 | 590° C. × 10 h | None | 15 | None |
| Comperative | 41 | 1.8 | 1.3 | 0.20 | 0.45 | 3.1 | 0.20 | 1.38 | 430° C. × 12 h | 430° C. × 6 h | 15 | None |
| example | | | | | | | | | | | | |
| Comperative | 42 | 2.5 | 0.7 | 0.20 | 0.50 | 3.3 | 0.20 | 3.57 | 430° C. × 12 h | 430° C. × 6 h | 15 | None |
| example | | | | | | | | | | | | |
| Present example | 43 | 2.1 | 1.3 | 0.20 | 0.45 | 3.1 | 0.20 | 1.62 | 450° C. × 9 h | 410° C. × 4 h | 15 | 200° C. × 7 h |
| Present example | 44 | 2.1 | 1.3 | 0.20 | 0.45 | 3.1 | 0.19 | 1.62 | 430° C. × 12 h | 430° C. × 6 h | 15 | 220° C. × 5 h |

TABLE 2

| | | Strength | Strength | | | Before brazing | | After brazing | | | |
|---|---|---|---|---|---|---|---|---|---|---|---|
| | | before | after | Melting | Electrical | Average | | Average | | | Crystal |
| | | brazing | brazing | point | conductivity | particle | Number | particle | Number | Crystal grain | grain size |
| Test material No. | | (MPa) | (MPa) | (° C.) | (% IACS) | diameter | density | diameter | density | structure | (μm) |
| Comparative | 1 | 240 | 172 | 623 | 39 | 79 | 10.0 | 89 | 7.0 | non- | 400 |
| example | | | | | | | | | | recrystallized | |
| Present example | 2 | 247 | 177 | 623 | 38 | 79 | 10.0 | 89 | 7.0 | non- | 400 |
| | | | | | | | | | | recrystallized | |
| Present example | 3 | 249 | 179 | 623 | 38 | 79 | 10.0 | 89 | 7.0 | non- | 400 |
| | | | | | | | | | | recrystallized | |
| Comparative | 4 | 255 | 170 | 623 | 36 | 79 | 10.0 | 89 | 7.0 | non- | 400 |
| example | | | | | | | | | | recrystallized | |
| Comparative | 5 | 235 | 169 | 619 | 41 | 77 | 8.8 | 87 | 5.8 | non- | 400 |
| example | | | | | | | | | | recrystallized | |
| Present example | 6 | 241 | 176 | 621 | 40 | 78 | 9.4 | 88 | 6.4 | non- | 450 |
| | | | | | | | | | | recrystallized | |
| Present example | 7 | 262 | 192 | 628 | 39 | 82 | 11.5 | 92 | 8.5 | non- | 600 |
| | | | | | | | | | | recrystallized | |
| Comparative | 8 | 268 | 173 | 630 | 37 | 84 | 12.1 | 94 | 9.1 | non- | 200 |
| example | | | | | | | | | | recrystallized | |
| Comparative | 9 | 235 | 170 | 635 | 39 | 77 | 8.8 | 87 | 5.8 | non- | 400 |
| example | | | | | | | | | | recrystallized | |
| Present example | 10 | 243 | 177 | 627 | 39 | 79 | 9.6 | 89 | 6.6 | non- | 450 |
| | | | | | | | | | | recrystallized | |
| Present example | 11 | 267 | 197 | 606 | 39 | 83 | 12.0 | 93 | 9.0 | non- | 600 |
| | | | | | | | | | | recrystallized | |
| Comparative | 12 | 275 | 205 | 595 | 39 | 85 | 12.8 | 95 | 9.8 | non- | 700 |
| example | | | | | | | | | | recrystallized | |
| Comparative | 13 | 245 | 174 | 623 | 39 | 79 | 9.8 | 89 | 6.8 | non- | 700 |
| example | | | | | | | | | | recrystallized | |
| Present example | 14 | 246 | 176 | 623 | 39 | 79 | 9.9 | 89 | 6.9 | non- | 600 |
| | | | | | | | | | | recrystallized | |
| Present example | 15 | 251 | 181 | 623 | 40 | 80 | 10.4 | 90 | 7.4 | non- | 400 |
| | | | | | | | | | | recrystallized | |
| Comparative | 16 | 254 | 172 | 623 | 40 | 81 | 10.7 | 91 | 7.7 | non- | 300 |
| example | | | | | | | | | | recrystallized | |
| Comparative | 17 | 245 | 171 | 627 | 40 | 79 | 9.8 | 89 | 6.8 | non- | 500 |
| example | | | | | | | | | | recrystallized | |
| Present example | 18 | 247 | 177 | 624 | 39 | 79 | 10.0 | 89 | 7.0 | non- | 500 |
| | | | | | | | | | | recrystallized | |
| Present example | 19 | 253 | 183 | 620 | 39 | 81 | 10.6 | 91 | 7.6 | non- | 400 |
| | | | | | | | | | | recrystallized | |
| Comparative | 20 | 261 | 191 | 615 | 39 | 82 | 11.4 | 92 | 8.4 | non- | 350 |
| example | | | | | | | | | | recrystallized | |
| Comparative | 21 | 247 | 177 | 623 | 39 | 79 | 10.0 | 89 | 7.0 | non- | 400 |
| example | | | | | | | | | | recrystallized | |
| Present example | 22 | 247 | 177 | 623 | 39 | 79 | 10.0 | 89 | 7.0 | non- | 400 |
| | | | | | | | | | | recrystallized | |
| Present example | 23 | 247 | 177 | 623 | 39 | 79 | 10.0 | 89 | 7.0 | non- | 400 |
| | | | | | | | | | | recrystallized | |
| Comparative | 24 | 247 | 177 | 623 | 39 | 79 | 10.0 | 89 | 7.0 | non- | 400 |
| example | | | | | | | | | | recrystallized | |
| Comparative | 25 | 212 | 135 | 625 | 43 | 71 | 6.2 | 81 | 4.3 | non- | 1300 |
| example | | | | | | | | | | recrystallized | |
| Present example | 26 | 232 | 187 | 621 | 40 | 78 | 9.4 | 88 | 3.4 | non- | 1600 |
| | | | | | | | | | | recrystallized | |
| Present example | 27 | 277 | 207 | 608 | 39 | 85 | 13.0 | 95 | 10.0 | non- | 350 |
| | | | | | | | | | | recrystallized | |
| Comparative | 28 | 290 | 207 | 608 | 39 | 85 | 13.0 | 95 | 10.0 | non- | 200 |
| example | | | | | | | | | | recrystallized | |
| Present example | 29 | 279 | 193 | 606 | 39 | 32 | 22.3 | 89 | 8.9 | non- | 1400 |
| | | | | | | | | | | recrystallized | |
| Present example | 30 | 275 | 192 | 606 | 39 | 47 | 16.3 | 92 | 8.8 | non- | 1300 |
| | | | | | | | | | | recrystallized | |
| Present example | 31 | 250 | 186 | 606 | 39 | 90 | 6.3 | 100 | 5.5 | non- | 400 |
| | | | | | | | | | | recrystallized | |
| Present example | 32 | 240 | 178 | 606 | 39 | 132 | 4.7 | 152 | 4.3 | non- | 310 |
| | | | | | | | | | | recrystallized | |
| Present example | 33 | 267 | 197 | 606 | 39 | 83 | 12.0 | 93 | 9.0 | non- | 450 |
| | | | | | | | | | | recrystallized | |
| Comparative | 34 | 283 | 207 | 608 | 39 | 85 | 13.0 | 95 | 10.0 | non- | 600 |
| example | | | | | | | | | | recrystallized | |
| Present example | 35 | 277 | 207 | 608 | 39 | 85 | 13.0 | 95 | 10.0 | non- | 500 |
| | | | | | | | | | | recrystallized | |
| Present example | 36 | 267 | 197 | 606 | 39 | 83 | 12.0 | 93 | 9.0 | non- | 600 |
| | | | | | | | | | | recrystallized | |
| Comparative | 37 | 282 | 193 | 603 | 39 | 40 | 17.5 | 48 | 8.7 | recrystallized | 1300 |
| example | | | | | | | | | | | |
| Present example | 38 | 240 | 178 | 606 | 39 | 112 | 4.9 | 144 | 5.1 | non- | 380 |
| | | | | | | | | | | recrystallized | |
| Present example | 39 | 240 | 180 | 606 | 39 | 123 | 6.0 | 144 | 3.2 | non- | 380 |
| | | | | | | | | | | recrystallized | |
| Present example | 40 | 238 | 177 | 606 | 39 | 134 | 4.2 | 154 | 4.7 | non- | 320 |
| | | | | | | | | | | recrystallized | |
| Comparative | 41 | 262 | 192 | 602 | 39 | 81 | 11.7 | 91 | 8.4 | non- | 550 |
| example | | | | | | | | | | recrystallized | |
| Comparative | 42 | 265 | 171 | 621 | 38 | 79 | 10.8 | 89 | 6.9 | non- | 400 |
| example | | | | | | | | | | recrystallized | |
| Present example | 43 | 265 | 192 | 606 | 39 | 47 | 16.3 | 92 | 8.8 | non- | 1300 |
| | | | | | | | | | | recrystallized | |
| Present example | 44 | 252 | 197 | 606 | 39 | 83 | 12.0 | 93 | 9.0 | non- | 600 |
| | | | | | | | | | | recrystallized | |

TABLE 3

| | | Resistance to | | Corrosion | Comprehensive |
|---|---|---|---|---|---|
| Test material No. | | brazing erosion | Corrugation moldability | resistance | evaluation |
| Comperative | 1 | ◯ | ◯ (2 or less fin ridges for NG) | ◯ | ◯◯ |
| example | | | | | |
| Present example | 2 | ◯ | ◯ (2 or less fin ridges for NG) | ◯ | ◯◯ |
| Present example | 3 | ◯ | ◯ (2 or less fin ridges for NG) | ◯ | ◯◯ |
| Comperative | 4 | ◯ | ◯ (2 or less fin ridges for NG) | ◯ | ◯◯ |
| example | | | | | |
| Comperative | 5 | ◯ | ◯ (2 or less fin ridges for NG) | ◯ | X |
| example | | | | | |
| Present example | 6 | ◯ | ◯ (2 or less fin ridges for NG) | ◯ | ◯◯ |
| Present example | 7 | ◯ | ◯ (2 or less fin ridges for NG) | ◯ | ◯◯◯ |
| Comperative | 8 | ◯ | ◯ (2 or less fin ridges for NG) | ◯ | X |
| example | | | | | |
| Comperative | 9 | ◯ | ◯ (2 or less fin ridges for NG) | ◯ | X |
| example | | | | | |
| Present example | 10 | ◯ | ◯ (2 or less fin ridges for NG) | ◯ | ◯◯ |
| Present example | 11 | ◯ | ◯ (2 or less fin ridges for NG) | ◯ | ◯◯◯ |
| Comperative | 12 | X | Δ | ◯ | X |
| example | | | | | |
| Comperative | 13 | ◯ | ◯ (2 or less fin ridges for NG) | ◯ | X |
| example | | | | | |
| Present example | 14 | ◯ | ◯ (2 or less fin ridges for NG) | ◯ | ◯◯ |
| Present example | 15 | ◯ | ◯ (2 or less fin ridges for NG) | ◯ | ◯◯ |
| Comperative | 16 | ◯ | ◯ (2 or less fin ridges for NG) | ◯ | X |
| example | | | | | |
| Comperative | 17 | ◯ | ◯ (2 or less fin ridges for NG) | ◯ | X |
| example | | | | | |
| Present example | 18 | ◯ | ◯ (2 or less fin ridges for NG) | ◯ | ◯◯ |
| Present example | 19 | ◯ | ◯ (2 or less fin ridges for NG) | ◯ | ◯◯ |
| Comperative | 20 | ◯ | ◯ (2 or less fin ridges for NG) | X | X |
| example | | | | | |
| Comperative | 21 | ◯ | ◯ (2 or less fin ridges for NG) | X | X |
| example | | | | | |
| Present example | 22 | ◯ | ◯ (2 or less fin ridges for NG) | ◯ | ◯◯ |
| Present example | 23 | ◯ | ◯ (2 or less fin ridges for NG) | ◯ | ◯◯ |
| Comperative | 24 | ◯ | ◯ (2 or less fin ridges for NG) | X | X |
| example | | | | | |
| Comperative | 25 | ◯ | X | ◯ | X |
| example | | | | | |
| Present example | 26 | ◯ | ◯ (2 or less fin ridges for NG) | ◯ | ◯◯◯ |
| Present example | 27 | ◯ | ◯ (4 fin ridges for NG) | ◯ | ◯◯◯ |
| Comperative | 28 | X | X | ◯ | X |
| example | | | | | |
| Present example | 29 | ◯ | Δ | ◯ | ◯ |
| Present example | 30 | ◯ | ◯ (4 fin ridges for NG) | ◯ | ◯◯◯ |
| Present example | 31 | ◯ | ◯ (2 or less fin ridges for NG) | ◯ | ◯◯◯ |
| Present example | 32 | ◯ | ◯ (2 or less fin ridges for NG) | ◯ | ◯◯ |
| Present example | 33 | ◯ | ◯ (2 or less fin ridges for NG) | ◯ | ◯◯◯ |
| Comperative | 34 | ◯ | X | ◯ | X |
| example | | | | | |
| Present example | 35 | ◯ | ◯ (4 fin ridges for NG) | ◯ | ◯◯◯ |
| Present example | 36 | ◯ | ◯ (2 or less fin ridges for NG) | ◯ | ◯◯◯ |
| Comperative | 37 | ◯ | X | ◯ | X |
| example | | | | | |
| Present example | 38 | ◯ | ◯ (2 or less fin ridges for NG) | ◯ | ◯◯ |
| Present example | 39 | ◯ | ◯ (2 or less fin ridges for NG) | ◯ | ◯◯ |
| Present example | 40 | ◯ | ◯ (2 or less fin ridges for NG) | ◯ | ◯◯ |
| Comperative | 41 | X | ◯ (2 or less fin ridges for NG) | ◯ | X |
| example | | | | | |
| Comperative | 42 | ◯ | ◯ (2 or less fin ridges for NG) | ◯ | X |
| example | | | | | |
| Present example | 43 | ◯ | ◯ (4 fin ridges for NG) | ◯ | ◯◯◯ |
| Present example | 44 | ◯ | ◯ (2 or less fin ridges for NG) | ◯ | ◯◯◯ |

As shown in the tables, all of the present Examples which satisfy the definitions of the present invention marked a comprehensive evaluation of ◯ or more with excellent results of strength, resistance to brazing erosion, moldability and corrosion resistance. By contrast, no good results were obtained in Comparative Examples which do not satisfy one or more definitions of the present invention.

Although embodiments of the present invention have been described and illustrated in detail, the disclosed embodiments are made for purposes of illustration and example only and not limitation. The scope of the present invention should be interpreted by terms of the appended claims.

1. An aluminum alloy fin material having a composition comprising, in % by mass, Zr: 0.05 to 0.3%, Mn: 1.8 to 2.5%, Si: 0.7 to 1.3%, Fe: 0.05 to 0.5%, Cu: 0.25 to 0.7%, Zn: 2.0 to 5.0%, with the balance being Al and inevitable impurities, wherein a ratio of Mn/Si in terms of content is in a range of 1.5 to 2.9, and the aluminum alloy fin material has a solidus temperature of 605° C. or more, a tensile strength before brazing of 210 to 280 MPa, and has a crystal grain structure before brazing of a non-recrystallized grain structure, a tensile strength after brazing of 175 MPa or more, an electrical conductivity after brazing of 37% IACS or more, and an average crystal grain size in a rolled surface after brazing of 300 μm to 2,000 μm.

2. The aluminum alloy fin material according to claim 1, wherein, Mn-containing Al—Mn-based particles having a circle-equivalent diameter of 400 nm or less among second phase particles distributed in matrix before brazing, have an average diameter in a range of 40 to 90 nm, and a number density thereof is within a range of 6 to 13 particles/μm².

3. The aluminum alloy fin material according to claim 1, wherein, Mn-containing Al—Mn-based particles having a circle-equivalent diameter of 400 nm or less among second phase particles distributed in matrix after brazing, have an average diameter in a range of 50 to 100 nm, and a number density thereof is 5 particles/μm² or more.

4. The aluminum alloy fin material according to claim 2, wherein, Mn-containing Al—Mn-based particles having a circle-equivalent diameter of 400 nm or less among second phase particles distributed in matrix after brazing, have an average diameter in a range of 50 to 100 nm, and a number density thereof is 5 particles/μm² or more.

5. A heat exchanger prepared by brazing the aluminum alloy fin material according to claim 1 and an aluminum material.

6. A heat exchanger prepared by brazing the aluminum alloy fin material according to claim 2 and an aluminum material.

7. A heat exchanger prepared by brazing the aluminum alloy fin material according to claim 3 and an aluminum material.
